(19) United States
(12) Patent Application Publication
(10) Pub. No.: US 2010/0233054 A1
(43) Pub. Date: Sep. 16, 2010

(54) CATALYST AND PROCESS FOR THE DESULFURIZATION OF HYDROCARBON-COMPRISING GASES

(75) Inventors: Jochen Steiner, Mannheim (DE); Markus Hoelzle, Kirchheim (DE); Heiko Urtel, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/672,219

(22) PCT Filed: Aug. 4, 2008
(86) PCT No.: PCT/EP08/60195

§ 371 Date: Feb. 4, 2010

(30) Foreign Application Priority Data
Aug. 9, 2007 (EP) 07114114.7

(51) Int. Cl. B01D 53/48; B01J 23/50; B01J 23/72; B01J 21/04

(52) U.S. Cl. 423/244.02; 502/347; 502/345; 502/348; 502/346

(57) ABSTRACT

The invention relates to a catalyst for the desulfurization of hydrocarbon-comprising gases, which comprises a support material, with the exception of activated carbons and zeolites, and a silver-comprising active composition, wherein the catalyst has a pore structure having a maximum number of the pores in a pore diameter range from 6 to 11 nm.

The invention further provides processes for producing such a catalyst, its use for the desulfurization of hydrocarbon-comprising gases, in particular in fuel cell applications, and a process for the desulfurization of hydrocarbon-comprising gases.

The invention relates to a catalyst and a process for the desulfurization of hydrocarbon-comprising gases, in particular for use in fuel cell systems.

Hydrocarbon-comprising gases such as natural gas comprise not only the sulfur compounds which normally occur naturally but also sulfur compounds which are added to these gases for safety reasons. Natural gas is predominantly desulfurized industrially by catalytic hydrogenation with addition of hydrogen. However, this desulfurization method is not suitable for small-scale and very small-scale applications, especially for fuel cells in the domestic sector, so that an adsorptive method is mainly used for purifying the gas stream here.

The hydrogen necessary for operation of fuel cells is usually obtained by reforming of natural gas. Natural gas has, especially in highly industrialized countries, the advantage of wide availability, since a closely linked supply network exists. In addition, natural gas has a high hydrogen/carbon ratio which is advantageous for hydrogen generation.

The term “natural gas” encompasses many possible gas compositions which can have a wide scatter as a function of the source. Natural gas can comprise virtually exclusively methane (CH4) but can also comprise appreciable amounts of higher hydrocarbons. For the purposes of the present invention, the term “higher hydrocarbons” refers to all hydrocarbons from ethane (C2H6) onward, regardless of whether they are linear saturated or unsaturated or cyclic or even aromatic hydrocarbons. The proportions of higher hydrocarbons in natural gas typically decrease with increasing molecular weight and increasing vapor pressure. Thus, ethane and propane are usually present in the low percentage range, while hydrocarbons having more than ten carbon atoms are usually comprised in amounts of only a few ppm in natural gas. The higher hydrocarbons also include cyclic compounds such as the carcinogenic benzene, toluene and xylenes. Each of these compounds can occur in concentrations of >100 ppm.

In addition to the higher hydrocarbons, further attendant materials and impurities which may comprise heteroatoms occur in natural gas. In this context, particular mention may be made of sulfur compounds which can occur in low concentrations. Examples are hydrogen sulfide (H2S), carbon oxide sulfide (COS) and carbon disulfide (CS2).

Methane or natural gas are themselves odorless gases which are not toxic, but in combination with air can lead to ignitable mixtures. To be able to detect escape of natural gas immediately, natural gas is admixed with foul-smelling substances in a low concentration. These odorizing agents produce the odor characteristic of natural gas. The odorization of natural gas is prescribed by law in most countries—together with the odorizing agents to be used. In some countries, e.g. the United States of America, mercaptans (R—S—H, R=alkyl radical) such as t-butyl mercaptan or ethyl mercaptan are used as odorizing agents, while in the member states of the European Union, cyclic sulfur compounds such as tetrahydrothiophene (THT) are usually used. Owing to chemical reactions which may occur, these mercaptans can form sulfides (R—S—R) and/or disulfides (R—S—S—R) which likewise have to be removed. Together with the naturally occurring sulfur compounds, there are therefore a large number of different sulfur compounds present in the natural gas. The various regulations concerning the composition of natural gas usually allow up to 100 ppm of sulfur in the natural gas. A similar situation applies to liquefied petroleum gas (LPG) as starting material. Liquefied petroleum gas, whose main constituents are propane and butane, has to be mixed with sulfur-comprising molecules as odor markers in the same way as natural gas.

The sulfur components in natural gas or in LPG can lead to severe and irreversible poisoning of the catalysts in the fuel cell or the reformer. For this reason, the gases which are fed into the fuel cell have to be freed of all sulfur-comprising components. Fuel cells therefore always comprise a desulfurization unit for the natural gas or LPG used. If the fuel cell is to be operated using liquid hydrocarbons such as heating oil, desulfurization is likewise necessary.

Preference is given to a mode of operation in which the hydrocarbon-comprising gas is conveyed in a single pass at room temperature through an adsorber which preferably removes all sulfur components completely. The adsorber should preferably be able to be operated at room temperature and at atmospheric pressure. Since the adsorber should be suitable for operation using natural gases of differing compositions, it is also important that only the sulfur-comprising components are adsorbed from the natural gas and the coadsorption of higher hydrocarbons is negligible. Only under these preconditions is it possible to achieve high adsorption capacities for sulfur-comprising compounds, which corresponds to sufficiently long periods of operation. In this way, frequent replacement of the adsorbent can be avoided.

The coadsorption of higher hydrocarbons, in particular benzene, from natural gas can also result in legal limits for benzene contents in the adsorber being exceeded and the adsorber unit thus being subject to compulsory labeling (carcinogenic). In addition, such adsorbers saturated with benzene incur considerable additional costs for, for example, replacing the adsorber medium or transporting the adsorber to recycling.

EP-A-1121977 discloses the adsorptive removal of sulfur-comprising, organic components such as sulfides, mercaptans and thiophenes from natural gas by means of silver-doped zeolites at room temperature.

Apart from the high silver content, a further significant disadvantage of the zeolite-based systems is the fact that zeolites readily adsorb all higher hydrocarbons occurring in the gas stream in their pore system. Cyclic hydrocarbons such as benzene, in particular, are completely adsorbed and can accumulate in the zeolite in amounts of up to a few % by weight.

US-A-2002/0159939 discloses a two-stage catalyst bed comprising an X-zeolite for the removal of odorizing agents and subsequently a nickel-based catalyst for the removal of sulfur-comprising components from natural gas for use in fuel cells. A disadvantage of this process is that COS cannot be removed directly but only after prior hydrolysis to H2S.

U.S. Pat. No. 5,763,350 proposes inorganic supports, preferably aluminum oxide, impregnated with a mixture of the oxides of elements of groups IB, IIB, VIB and VIIIB of Periodic Table of the Elements, preferably a mixture of Cu, Fe, Mo and Zn oxides, for the removal of sulfur compounds. Here too, the sulfur compounds are firstly hydrolyzed to H2S.

According to DE-A-3525871, organosulfur compounds such as COS and CS2 comprised in gas mixtures are quantitatively removed together with sulfur oxides and/or nitrogen oxides in the presence of catalysts comprising compounds of Sc, Y, the lanthanides, actinides or mixtures thereof on, for example, aluminum oxide. The catalysts are dried and sintered at from 100 to 1000° C. during their production.

According to U.S. Pat. No. 6,024,933, direct oxidation of the sulfur components to elemental sulfur or sulfates occurs over a copper catalyst which is supported on, for example, aluminum oxide and comprises at least one further catalytically active element selected from the group consisting of Fe, Mo, Ti, Ni, Co, Sn, Ge, Ga, Ru, Sb, Nb, Mn, V, Mg, Ca and Cr.

WO 2007/021084 describes a copper-zinc-aluminum composite which is calcined at from 200 to 500° C. as desulfurizing agent.

The processes of the prior art do not solve the problem of the undesirable coadsorption of hydrocarbons, in particular cyclic hydrocarbons such as benzene, occurring in the gas stream in the pore system of the catalyst. A further disadvantage is that the adsorption of higher hydrocarbons sometimes leads to pyrophoric adsorbents, i.e. these can catch fire if an ignition source is present when the exhausted catalyst is removed from the adsorber.

It was therefore an object of the present invention to develop a catalyst which has a high uptake capacity for sulfides, disulfides and cyclic odorizing agents, in particular tetrahydrothiophene (THT), and at the same time suppresses the coadsorption of benzene.

The object is achieved according to the invention by a catalyst comprising a support material, with the exception of activated carbons and zeolites, and a silver-comprising active composition being used for the desulfurization of hydrocarbon-comprising gases, with the catalyst having a particular pore structure.

The invention provides a catalyst for the desulfurization of hydrocarbon-comprising gases, which comprises a support material, with the exception of activated carbons and zeolites, and a silver-comprising active composition, wherein the catalyst has a pore structure having a maximum number of the pores in a pore diameter range from 6 to 11 nm, and processes for producing it.

The invention further provides for the use of this catalyst for the desulfurization of hydrocarbon-comprising gases, in particular in fuel cell applications, and a process for the desulfurization of hydrocarbon-comprising gases.

Embodiments of the present invention can be derived from the claims, the description and the examples. It goes without saying that the abovementioned features and the features still to be explained below of the subject matters of the invention can be used not only in the combinations indicated in each case but also in other combinations without going outside the scope of the invention.

As support material, the catalyst of the invention can comprise all materials which a person skilled in the art would consider to be suitable for this purpose, with the exception of activated carbons and zeolites, as long as they have the pore structure which is necessary according to the invention.

An advantageous support material is an aluminum oxide which may comprise impurities typical of aluminum oxide. Particular preference is given to using a pure y-aluminum oxide.

The catalyst of the invention comprises at least silver, advantageously also copper, as active component(s). The active components are preferably present as oxide in the catalyst. The following figures for metal loading (metal contents) of the catalyst are calculated as pure metal.

The catalyst of the invention advantageously has a silver content of not more than 5% by weight, preferably less than 4% by weight and particularly preferably from 2 to 3% by weight, and, if appropriate, a copper content of not more than 5% by weight, preferably less than 4% by weight and particularly preferably from 0.5 to 3% by weight, in each case based on the total weight of the catalyst. The total content of the active composition is not more than 10% by weight, preferably less than 8% by weight and particularly preferably from 2.5 to 6% by weight, in each case based on the total weight of the catalyst.

Further advantageous ranges for the amounts are, for example, from 2 to 3% by weight of Ag and from 1 to 3% by weight of Cu, in each case based on the total weight of the catalyst.

A preferred embodiment of the catalytically active system comprises, on an aluminum oxide support, advantageously a y-aluminum oxide support, from 2 to 3% by weight of Ag and from 1 to 2% by weight of Cu, in each case based on the total weight of the catalyst.

Further embodiments of the chemical composition of the catalyst of the invention may be found in the examples. It goes without saying that the abovementioned features and features still to be indicated below of the catalyst can be used not only in the combinations and value ranges indicated but also in other combinations and value ranges within the limits of the main claim without going outside the scope of the invention.

Furthermore, the active component and/or the support material can be doped with small amounts of further elements which can be used for this purpose and are known to those skilled in the art without going outside the scope of the invention.

The catalyst of the invention has a pore structure having a maximum number of the pores in a pore diameter range from 6 to 11 nm. The catalyst advantageously comprises at least 50%, preferably at least 60% and particularly preferably at least 80%, of pores in this size range.

The catalyst of the invention has only a small number of pores smaller than 6 nm. The catalyst advantageously comprises not more than 25%, preferably not more than 20% and particularly preferably not more than 10%, of pores in this size range. It preferably comprises virtually no pores smaller than 6 nm.

The catalyst of the invention has only a small number of pores larger than 11 nm. The catalyst advantageously comprises not more than 25%, preferably not more than 20% and particularly preferably not more than 10%, of pores in this size range. It preferably comprises virtually no pores larger than 11 nm.

The pore structure of the catalyst material is determined in a manner known to those skilled in the art by porosimetry measurements, for example by mercury porosimetry, e.g. using Auto Pore IV 9500 from Micromeritics.

A catalyst having such a pore structure ensures that the sulfur components comprised in the hydrocarbon-comprising gas can be removed completely without significant coadsorption of higher hydrocarbons occurring. In particular, the uptake of benzene is suppressed.

The catalyst of the invention has a high uptake capacity for sulfur compounds such as sulfides, disulfides and cyclic sulfur compounds, in particular cyclic odorizing agents, preferably tetrahydrothiophene (THT). It is at least 0.6% by weight of THT, i.e. 0.6 g of THT/100 g of catalyst.

The required pore structure is achieved by calcination of the catalyst material at from 500 to 800° C., preferably from 550 to 750° C. When this temperature level is adhered to, pores having a diameter of from 6 to 11 nm are predominantly formed.

If calcination is carried out at a lower temperature, a pore structure having a maximum number of the pores in a pore diameter range of less than 6 nm is formed, which leads to significant adsorption of benzene and higher hydrocarbons.

If calcination is carried out at a higher temperature, a pore structure having a maximum number of the pores in a pore diameter range above 11 nm is formed, which leads to a significantly lower capacity for adsorbed sulfur species, especially tetrahydrothiophene.

The catalysts of the invention can, apart from adherence to the specific calcination temperature described above, be produced by generally known processes, for example by precipitation, impregnation, mixing, kneading, sintering, spraying, spray drying, ion exchange or electroless deposition, preferably by precipitation, impregnation, mixing, sintering or spray drying, particularly preferably by precipitation or impregnation, in particular by impregnation. For example, the active components and, if appropriate, doping elements, preferably in the form of their salts/hydrates, are brought into solution and then applied in a suitable way, for example by impregnation, to the aluminum oxide support. The catalyst is then dried, calcined, reduced if appropriate and passivated if appropriate. The production of shaped bodies from pulverulent raw materials can be effected by customary methods known to those skilled in the art, for example tableting, aggregation or extrusion.

In an advantageous production process, the following process steps are carried out:
mixing of the starting materials (aluminum oxide, silver salt solution with or without copper salt solution)
extrusion of the mixture
drying at above 100° C.
calcination at from 500 to 800° C.

In a further advantageous production process, the following process steps are carried out:
production of the support material by mixing of the starting materials for the support material, comprising at least aluminum oxide, subsequent extrusion of the support composition and drying at above 100° C.,
calcination of the support at from 500 to 800° C.,
impregnation of the support material with at least one silver salt solution,
if appropriate, subsequent impregnation with copper salt solution,
drying at above 100° C. and calcination at from 500 to 800° C.

Impregnation with copper salt solution, if used, can also be carried out before impregnation with silver salt solution. As an alternative, simultaneous impregnation with a solution comprising a silver salt and a copper salt is also possible.

In addition, further process steps customarily employed in the production of catalysts can be carried out in the two advantageous process variants.

The result is a catalyst which is eminently suitable for the desulfurization of hydrocarbon-comprising gases. It is able to adsorb the sulfur-comprising components from the hydrocarbon-comprising gas, in particular natural gas, and suppress the coadsorption of higher hydrocarbons to a negligible level. This makes it possible to achieve high adsorption capacities for sulfur-comprising compounds and thus sufficiently long periods of operation, as a result of which frequent replacement of the adsorbent can be avoided. In addition, the catalyst of the invention is suitable for the purification of hydrocarbon-comprising gases having differing compositions.

The process of the invention for the desulfurization of hydrocarbon-comprising gases is carried out using such an above-described catalyst.

The hydrocarbon-comprising gas which is contaminated by sulfur compounds can be passed at a temperature of from (−50) to 150° C., preferably from (−20) to 80° C., particularly preferably from 0 to 80° C., in particular from 15 to 60° C., very particularly preferably at room temperature, and a pressure of from 0.1 to 10 bar, preferably from 0.5 to 4.5 bar, particularly preferably from 0.8 to 1.5 bar, in particular at atmospheric pressure, over one or more catalysts according to the invention.

The hydrocarbon-comprising gas is advantageously conveyed through this catalyst in a single pass. The process is particularly preferably operated at room temperature and atmospheric pressure.

The catalyst of the invention after sulfur breakthrough advantageously has a content of higher hydrocarbons, in particular a benzene content, of less than 0.1% by weight.

The catalyst of the invention after tetrahydrothiophene breakthrough advantageously has a benzene content of less than 0.1% by weight.

The uptake capacity of the catalysts is calculated from the mean THT concentration of the test gas and the time for which no breakthrough of THT is detected by the on-line GC. A generally applicable formula is: capacity [g/l]=(concentration [mg/m3]×gas volume [m3/h]×running time [h])/(volume of catalyst [m3]×1 000 000). The running time is the time for which no sulfur compound is detected by the GC. The gas volume corresponds to the test gas flow under standard conditions.

Since the THT capacity of the catalyst depends on the concentration because of the physisorptive interaction, only THT concentrations which correspond to a realistic odorization of gas supply networks are used for testing. For this reason, a gas stream comprising an average of 3 ppm by volume of THT and 60 ppm by volume of benzene is used as test gas.

The sulfur components are removed completely by the desulfurization process of the invention. For the purposes of the present invention, completely means removal to below the presently possible detection limit in measurement by means of GC, which is 0.04 ppm. The process and the catalyst of the invention are therefore eminently suitable for, in particular, use in fuel cell applications.

In a fuel cell system, the process of the invention can precede the reforming stage. Here, the hydrocarbon-comprising gas used, after purification according to the invention, for producing hydrogen can be fed directly into the reformer or directly into the fuel cell. The process of the invention is suitable for all known types of fuel cells, e.g. low-temperature and high-temperature PEM fuel cells, phosphoric acid fuel cells (PAFCs), melt carbonate fuel cells (MCFCs) and high-temperature fuel cells (SOFCs).

When the process of the invention is employed in conjunction with a fuel cell, it can be advantageous for the exhausted catalyst not to be regenerated directly in the system but for it to be replaced and regenerated separately after removal from the system. This applies particularly to low-power fuel cells.

When it is necessary to remove the catalyst from the fuel cell system, it can be disposed of since it is not classified as dangerous goods because of the reduced coadsorption of benzene.

In the case of fuel cells of larger power units, it can, on the other hand, be useful to regenerate the catalyst entirely or at least partly in the system. The known methods, e.g. thermal desorption at temperatures above 200° C., can be employed for this purpose.

The process of the invention is particularly suitable for use in stationary and mobile applications. Preferred applications in the stationary sector are, for example, fuel cell systems for the simultaneous generation of power and heat, e.g. combined heat and power (CHP) units, preferably for domestic energy supply. Furthermore, the system is suitable for the purification of gas streams for the desulfurization of natural gas for gas engines. In the case of applications in the mobile sector, the process can be used for the purification of hydrocarbons for fuel cells in passenger cars, goods vehicles, buses or locomotives, preferably passenger cars and goods vehicles, particularly preferably passenger cars. Here, it is immaterial whether the fuel cells are used purely for onboard generation of electric power or for powering the vehicle.

The invention is illustrated by the following examples without being restricted thereby.

### EXAMPLES

### Example 1

Aluminum oxide powder was mixed with Cu nitrate and Ag nitrate in a mixer, diluted with water and acidified with a little formic acid. The amount of Cu nitrate and Ag nitrate was calculated so that the calcined catalyst bore an active composition of 2% by weight of copper and 2% by weight of silver. The resulting mass was subsequently admixed with additional water, kneaded to form an extrudable mass and subsequently extruded. The extrudates were dried at 120° C. and subsequently calcined at differing temperatures, as indicated in Examples 1a) to 1c) for a number of hours.

### Example 1a)

### Calcination of Catalyst from Example 1 at 450° C.

The resulting catalyst had a total pore volume of 0.34 ml/g and a surface area of 235.4 m2/g
The catalyst had a pore structure having a maximum of the pore diameter at 5.6 nm (values from Hg porosimetry)—FIGS. 1a/1b

### Example 1b)

### Calcination of Catalyst from Example 1 at 700° C.

The resulting catalyst had a total pore volume of 0.38 ml/g and a surface area of 201.64 m2/g
The catalyst had a pore structure having a maximum of the pore diameter at 7.3 nm (values from Hg porosimetry)—FIGS. 2a/2b

### Example 1c)

### Calcination of Catalyst from Example 1 at 1000° C.

The resulting catalyst had a total pore volume of 0.22 ml/g and a surface area of 57.3 m2/g
The catalyst had a pore structure having a maximum of the pore diameter at 12 nm (values from Hg porosimetry)—FIGS. 3a/3b

Table 1 shows the pore distribution in the samples from Examples 1a-1c.

The percentage of total pores includes the pores which are in the claimed pore diameter range from 6 to 11 nm and are particularly preferably suitable for the adsorption of THT without coadsorption of benzene.

TABLE 1

| | Pore volume | | | | |
|---|---|---|---|---|---|
| Temperature | <6 nm | 6-11 nm | % of total pores | >11 nm | Total |
| Ex. 1a (450° C.) | 0.286 | 0.036 | 10.6 | 0.018 | 0.340 |
| Ex. 1b (700° C.) | 0.021 | 0.338 | 88.9 | 0.021 | 0.380 |
| Ex. 1c (1000° C.) | 0.001 | 0.033 | 14.9 | 0.187 | 0.221 |

FIG. 4 shows the dependence of the pore distribution on the calcination temperature in the samples from Examples 1a-1c.

### Example 2

### Standard Activated Carbon without Doping

### Example 3

250 g of an Na-Y zeolite (CBV® 100 from Zeolyst Int. having an Si/AI ratio of 5.1) were admixed with 2.5 l of a 0.5 molar solution of silver nitrate (424.6 g) while stirring, heated at 80° C. for 4 hours, the precipitation product was filtered off, washed once with 500 ml of water, dried at 120° C. for 2 hours, calcined at 500° C. for 4 hours (heating rate: 1° C./min), heated again with 2.5 l of a 0.5 molar silver nitrate solution at 80° C. for 4 hours, filtered off, washed with 500 ml of water, dried overnight at 120° C. This gave 372 g of the catalyst.

### Experimental Procedure

All catalysts or adsorbents were used as 1.5 mm extrudates. A heatable stainless steel tube through which the gas was passed from the top downward served as reactor. 40 ml of catalyst were used per experiment.

A commercially available natural gas (from Linde) was used.

An average of 3 ppm by volume of THT and 60 ppm by volume of benzene were introduced into the gas in a saturator and the gas was passed over the catalyst at a volume flow of 250 standard liters per hour (corresponds to a GHSV of 6250 h⁻1). All measurements were carried out at standard pressure (1013 mbar) and room temperature. Pretreatment of the catalyst (e.g. reduction) is not necessary.

A commercial gas chromatograph having a two column arrangement and two detectors was used to analyze the gas downstream of the reactor. The first detector, a flame ionization detector (FID), served to detect the individual hydrocarbons in the natural gas, in particular benzene. The second detector, a flame photometric detector (FPD), was sensitive to sulfur compounds and allowed the detection of such compounds down to a practical detection limit of 0.04 ppm.

Tetrahydrothiophene (THT) was chosen as model substance for organic sulfur compounds since it is known that cyclic sulfur compounds can be removed only with great difficulty by means of adsorption, in contrast to terminal sulfur compounds.

Results and comparison:

TABLE 2

| | THT capacity | Benzene uptake |
|---|---|---|
| Example | [g/l] | % by weight |
| 1a | 6.2 | >0.1 |
| 1b | 10.2 | <0.1 |
| 1c | 3.9 | <0.1 |
| 2 | 5.2 | 2 |
| 3 | 26.4 | >3.5 |

As can be seen from Table 2, Comparative Examples 2 and 3 do have a significantly higher volume-based capacity for THT but both materials adsorb large amounts of benzene. Owing to legal requirements, these would have to be classified as toxic substances, which is important in terms of the disposal of the used adsorbents.

The causes of the significant differences in the THT capacities are primarily to be found in the pore structure of the adsorbents, since optimization of the capacity is possible by adjustment of the pore radius distribution by means of suitable calcination temperatures. Here, the pores in the range from 6 to 11 nm are of particular importance since THT can be adsorbed effectively in these while coadsorption of benzene is suppressed.

1. A catalyst for the desulfurization of hydrocarbon-containing gases, which comprises a support material, with the exception of activated carbons and zeolites, and a silver-containing active composition, wherein the catalyst has a pore structure having a maximum number of the pores in a pore diameter range from 6 to 11 nm.

2. The catalyst according to claim 1, wherein the silver content is not more than 5% by weight, based on the total weight of the catalyst.

3. The catalyst according to claim 1, wherein the active composition comprises copper.

4. The catalyst according to claim 1, wherein the copper content is not more than 5% by weight, based on the total weight of the catalyst.

5. The catalyst according to claim 1, wherein the support material comprises aluminum oxide.

6. The catalyst according to claim 1, which has virtually no pores smaller than 6 nm.

7. The catalyst according to claim 1, which has virtually no pores larger than 11 nm.

8. A process for producing a catalyst according to claim 1, which comprises at least
mixing of the starting materials comprising at least aluminum oxide and a silver salt solution,
extrusion of the mixture,
drying at above 100° C. and
calcination at from 500 to 800° C.

9. The process for producing a catalyst according to claim 8, wherein a copper salt solution is additionally used as starting material.

10. A process for producing a catalyst according to claim 1, which comprises at least
mixing of the starting materials of the support material, comprising at least aluminum oxide,
extrusion of the support composition,
drying of the support composition at above 100° C.,
calcination of the support at from 500 to 800° C.
impregnation of the support with at least one silver salt solution,
drying at above 100° C. and
calcination at from 500 to 800° C.

11. The process for producing a catalyst according to claim 10, wherein the support is additionally impregnated with a copper salt solution before or after impregnation with the silver salt solution.

12. The process for producing a catalyst according to claim 10, wherein the support is impregnated with a solution comprising at least a silver salt and a copper salt.

13. (canceled)

14. A process for the catalytic desulfurization of gases, wherein the catalyst comprises a support material, with the exception of activated carbons and zeolites, and a silver-containing active composition, said catalyst having a pore structure having a maximum number of the pores in a pore diameter range from 6 to 11 nm.

15. The process according to claim 14, wherein the catalyst after sulfur breakthrough has a benzene content of less than 0.1% by weight.

16. The process according to claim 14, wherein the catalyst after tetrahydrothiophene breakthrough has a benzene content of less than 0.1% by weight.

17. The process according to claim 14, wherein the desulfurization of hydrocarbon-containing gases is carried out at temperatures of up to 70° C.

18. The process according to claim 14, which is installed upstream of the reforming stage in a fuel cell system.

19. A component for hydrogen production for fuel cell applications comprising the catalyst according to claim 1.
